(19) United States
(12) Patent Application Publication
(10) Pub. No.: US 2026/0087409 A1
(43) Pub. Date: Mar. 26, 2026

(54) SINGLE TRAJECTORY POLICY OPTIMIZATION FOR GENERATIVE MACHINE LEARNING MODELS

(71) Applicant: GDM Holding LLC, Mountain View, CA (US)

(72) Inventors: Bilal Piot, London (GB); Pierre Richemond, London (GB); Yunhao Tang, London (GB); Daniele Calandriello, Paris (FR); Zhaohan Guo, London (GB); Gil Shamir, Sewickley, PA (US); Tianqi Liu, Jersey City, NJ (US); Rishabh Joshi, San Jose, CA (US); Lior Shani, Haifa (IL); Eugene Tarassov, Villennes-sur-Seine (FR); Remi Munos, Le Vesinet (FR); Bernardo Avila Pires, London (GB); Lucas Joseph Spangher, San Francisco, CA (US); Mohammad Gheshlaghi Azar, Seattle, WA (US); Rafael Mitkov Rafailov, Stanford, CA (US)

(21) Appl. No.: 19/216,677

(22) Filed: May 22, 2025

Related U.S. Application Data
(60) Provisional application No. 63/650,906, filed on May 22, 2024.

(51) Int. Cl. G06N 20/00

(52) U.S. Cl. CPC G06N 20/00

(57) ABSTRACT

Methods, systems, and apparatus, including computer programs encoded on a computer storage medium, for training a generative machine learning machine learning models to perform a machine learning task. In one aspect, a method comprises at each of a sequence of training iterations for a target generative model: obtaining a plurality of training examples that each include an example prompt, an example data item, and a quality score for the example data item; determining likelihoods of the target generative machine learning model generating the example data items for the training examples; determining expected quality scores for the training examples; and training the target generative machine learning model to optimize an objective function that depends on the likelihoods of the target generative machine learning model generating the example data items for the training examples and a difference between the quality scores and the expected quality scores for the training examples.

### CROSS-REFERENCE TO RELATED APPLICATION

This application claims priority to U.S. Provisional Application No. 63/650,906, filed on May 22, 2024. The disclosure of the prior application is considered part of and is incorporated by reference in its entirety in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a method for training (e.g., fine-tuning or aligning) a generative machine learning model to perform a machine learning task. In particular, the described methods can be used to train the generative machine learning model to generate outputs that are aligned with human preferences using quality scores assigned to individual outputs.

According to one aspect, there is provided a method, performed by one or more computers, comprising: training a target generative machine learning model, the training comprising, at each of a sequence of training iterations: obtaining a plurality of training examples for the training iteration, wherein each training example includes (i) an example prompt for the training example, (ii) an example data item for the training example, and (iii) a quality score for the training example that measures a quality of the example data item given the example prompt; determining, for each of the plurality of training examples for the training iteration, a likelihood of the target generative machine learning model generating the example data item by processing the example prompt for the training example; determining, for each of the plurality of training examples for the training iteration, an expected quality score for the training example; and training the target generative machine learning model to optimize an objective function, wherein the objective function depends on, for each training example for the training iteration, (i) the likelihood of the target generative machine learning model generating the example data item by processing the example prompt for the training example and (ii) a difference between the quality score for the training example and the expected quality score for the training example.

The target generative machine learning model can be configured to perform a machine learning task and the training examples for training the target generative machine learning model can include example prompts and example data items for performing the machine learning task.

As one example, the machine learning task can involve interacting with a user to perform the task, e.g., by generating responses to queries received from the user. When the machine learning task involves interacting with a user, the example prompt for a training example can include examples of queries from an example user and the example data item for the training example can include example responses to the examples of queries from the example user.

As another example, the machine learning task can be to select actions for an agent interacting with an environment to perform a task in the environment. The example data items for a training example can include example selected actions for an example agent to perform the task in an example environment for the training example. The example prompts can include example observations of the example environment for the training example.

The described systems can train the target generative model using quality scores for the example data items that can be directly determined from the example data items and, optionally, the corresponding example prompts. For example, the quality score for an example data item can be a performance metric for a downstream task performed using the example data item. As another example, the quality score for an example data item can characterize direct human feedback for the example data item (e.g., a human rating of the example data item, a human classification of the example data item, etc.).

The subject matter described in this specification can be implemented in particular embodiments so as to realize one or more of the following advantages.

The described systems and methods enable efficient fine-tuning and alignment of generative models using feedback (e.g., human feedback) regarding the quality of example outputs. Fine-tuning using human feedback can enable generative models to learn human preferences regarding model outputs and to generate more preferable outputs. Fine-tuning large generative models, such as large language models (LLMs) and vision-language models (VLMs), with human feedback is particularly useful in many applications, as these large models can have the computational capability of accurately modeling human preferences and of generating high quality outputs.

Conventional methods for fine-tuning using feedback, such as reinforcement learning from human feedback (RLHF) or direct policy optimization (DPO), typically fine-tune generative models using training data demonstrating pair-wise preferences between example outputs. Conventional methods therefore typically utilize training examples that each include an example input (e.g., an example prompt), two example outputs (e.g., example responses or prompt completions), and data specifying a preference (e.g., a human preference) between the two example outputs.

Such pair-wise preference data is often scarce and can be difficult to obtain. In particular, determining pair-wise preferences comparing pairs of example outputs can be more resource intensive and less natural compared to obtaining direct feedback for individual example outputs, such as ratings or scores for the example outputs. Further, determining pair-wise preferences between example outputs can become more difficult as the quality of the example outputs improves, which can further increase the difficulty of fine-tuning highly capable generative models such as LLMs and VLMs.

To address these challenges, the described systems perform fine-tuning using direct human feedback for individual example outputs. In particular, the described systems can fine-tune generative models using single-trajectory training examples that each include an example input (e.g., an example prompt), a single example output (e.g., an example response or prompt completion), and a quality score characterizing feedback (e.g., a rating or score) for the example output. Compared to pair-wise preference data, such single-trajectory training data can be more abundant and more easily collected and can require fewer computational resources (e.g., training time, memory, etc.) to process as part of training. By training using direct human feedback for individual example outputs, the described systems can therefore train generative models using human feedback more efficiently and using more easily obtained training data compared to conventional methods that require pairwise preference data.

By more efficiently fine-tuning generative models, the described systems can be used to reduce training and inference costs (e.g., computational time, memory usage, etc.). For example, training using quality scores for individual example outputs can enable the described systems to more efficiently train (e.g., using fewer training examples, over fewer training iterations, etc.) a same generative model to a desired level of performance in the machine learning task as compared to conventional training methods that utilize pair-wise preference data. As another example, training using quality scores for individual example outputs can enable the described systems to train a smaller, less complex generative model to attain a desired level of performance as compared to conventional training methods that utilize pair-wise preference data, which can further reduce computational costs of both training and inference of the model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for training a generative machine learning model.

FIG. 3 illustrates an example algorithm that a training system can use to train a generative machine learning model.

FIG. 4 is a flow diagram of an example process for generating an expected quality score by processing an input prompt using a score prediction machine learning model.

FIG. 5 illustrates a performance of example generative machine learning models that have been trained using the described methods.

Like reference numbers and designations in the various drawings indicate like elements.

### DETAILED DESCRIPTION

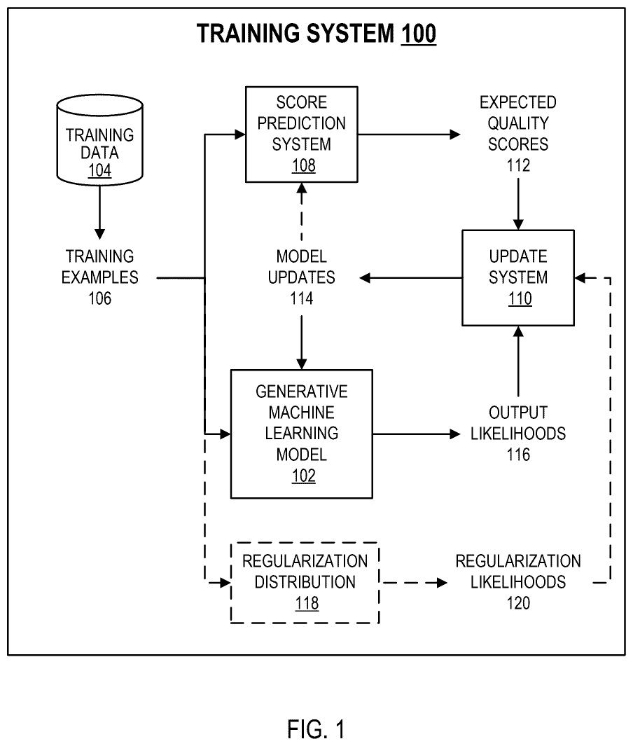

FIG. 1 shows an example training system 100. The training system 100 is an example of a system implemented as computer programs on one or more computers in one or more locations in which the systems, components, and techniques described below are implemented.

The training system 100 can train a generative machine learning model 102 (e.g., a target generative machine learning model) to perform a machine learning task using a set of training data 104 for the machine learning task.

The machine learning task can be any of a variety of tasks. For example, the machine learning task can include receiving an input query (e.g., an input prompt) from a user and processing the received query to generate an output as a response to the received query. The machine learning task can include, e.g., generating output text, an output image, output audio, an output video, and so on in response to a user query. As another example, the machine learning task can include selecting actions for an agent interacting with an environment to perform a task in the environment. As a further example, the machine learning task can include processing data characterizing the environment (e.g., data characterizing an observation of the environment) as a model input to generate a selected action for the agent as the model output.

The generative machine learning model 102 can have any appropriate architecture for processing input prompts (e.g., model inputs) for the machine learning task to generate output data items (e.g., model outputs) for the machine learning task. In particular, the generative machine learning model 102 can be a neural network that includes any of a variety of processing layers (e.g., feedforward layers, convolutional layers, recurrent layers, attention layers, graph processing layers, etc.) in any appropriate combination for performing the machine learning task.

For example, the generative machine learning model 102 can be a sequence processing neural network configured to generate output sequences (e.g., output token sequences) representing output data items for the machine learning task by processing input sequences (e.g., input token sequences) representing input prompts for the machine learning task. As a further example, the generative machine learning model 102 can be an auto-regressive generative model (e.g., a Transformer, a recurrent neural network, etc.) that can auto-regressively generate output sequences for the machine learning task. A transformer neural network is a neural network that includes a stack of transformer blocks, each typically including an attention or self-attention neural network layer, generally followed by a feedforward neural network layer (where a self-attention neural network layer applies a self-attention operation, e.g., QKV self-attention, to elements of an embedding, to update each element of the embedding).

The generative machine learning model 102 can, for example, be a large language model (LLM) that can generate tokenized representations of text data; a vision-language model (VLM) that can generate tokenized representations of image or video data, e.g., in response to a text input or that can generate tokenized representations of text, e.g., in response to an image input; an audio model that can input or generate tokenized representations of audio data; or a multimodal model that can generate output token sequences representing text data, image data or audio data, e.g., in response to inputs characterizing input text, input images input audio; and so on.

Generally, prior to the training of the generative machine learning model 102 by the system 100, the generative machine learning model 102 can have already been trained across one or more previous training stages.

For example, the one or more previous training stages can include a pre-training stage. During the pre-training stage, the generative machine learning model 102 can have been trained by the system 100 or a separate system on a next token prediction task, e.g., a task that requires predicting, given a current sequence of tokens, the next token that follows the current sequence in the training data.

As a particular example, the generative machine learning model 102 can have been trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

As another example, the one or more previous training stages can include one or more additional training stages, e.g., that occur after the pre-training stage. For example, the one or more previous training stages can include any one or more of: a supervised fine-tuning stage, a reinforcement learning stage, a preference learning stage, an instruction tuning stage, and so on.

Such training of the generative machine learning model 102 over the one or more previous training stages can enable the training system 100 to more efficiently train the model 102 to perform the machine learning task (e.g., using less training data, fewer training iterations, etc.).

In particular, the training system 100 can efficiently fine-tune or align the generative machine learning model 102 to generate more preferable outputs for the machine learning task using the training data 104. When the generative machine learning model 102 is a large generative model, such as a large language model or a vision-language model with hundreds of millions or billions of parameters, the generative machine learning model 102 can have a computational capability to accurately model human preferences for the machine learning task and to generating high quality (e.g., more preferable) outputs for the machine learning task. While the one or more previous training stages of the generative machine learning model 102 can enable the model to process inputs and generate outputs for the machine learning task, the model 102 often requires additional fine-tuning to correctly model preferences regarding the machine learning task. By fine-tuning the generative machine learning model 102 using training data 104 that includes feedback (e.g., human feedback) for example outputs for the machine learning task, the training system 100 can specifically fine-tune the model 102 to produce more preferable outputs for the machine learning task.

Example machine learning tasks and example architectures for the generative machine learning model 102 are described in more detail later in this specification.

The training data 104 for the machine learning task can include a plurality of training examples 106 for the machine learning task. Each of the training examples 106 can include an example prompt (e.g., an example model input) for the training example, an example output data item (e.g., an example model output) for the training example, and a quality score for the training example that measures a quality of the example data item for the training example.

The quality score for each training example can be a task reward for the machine learning task that characterizes, e.g., a degree of success, an accuracy, and so on associated with the generative machine learning model 102 performing the machine learning task by processing the example prompt for the training example to generate the example data item for the training example.

In general, the system 100 can receive the quality scores for the training examples from any of a variety of sources, e.g., from a user, from another system, as an output from a trained model (e.g., a reward model).

The quality score for each training example can be determined based on the example prompt and the example data item for the training example. The quality score for each training example can be determined based on, for example, rating or preference information corresponding to the example data item for the training example, as provided by a user or a trained machine model. The quality score for each training example can be determined based on execution of one or more processes based on the example data item for the training example. For example, an example data item can include computer language such as programming code which, when executed by a computer, causes the computer to carry out a process and the quality score for the example data item can be determined based on the execution of the process, for example based on whether the process was successfully executed to completion, or based on metrics relating to the process such as memory usage for example. In another example, an example data item can include data representing actions to be taken by an agent (e.g., a mechanical agent such as a robot) and the quality score for the example data item can be determined based on the execution of the action, for example in a simulated environment or a real world environment.

The quality scores for the training examples can be determined using a trained reward model (e.g., a preference prediction machine learning model). The reward model can have been trained using a dataset comprising, example prompts, example data items, and target quality scores based on rating or preference information or based on execution of a process, for example.

The training system 100 includes a score prediction system 108 and an update system 110, which are each described next (and throughout this specification).

The score prediction system 108 can process each of the training examples to generate expected quality scores 112 for the training examples. The expected quality score for each of the training examples 106 can be a predicted expected (e.g., average) quality score of data items generated in accordance with a reference distribution for the training example (e.g., a reference conditional distribution of data items for the training example given the prompt for the training example). The reference distribution for each training example can be a distribution of data items determined using a reference generative machine learning model configured to process input prompts for the machine learning task to generate output data items for the machine learning task.

The reference generative machine learning model can have any appropriate architecture for processing the example prompts to generate data items for the machine learning task. In some implementations, the reference generative machine learning model can have a same network architecture as the target generative machine learning model 102. In other implementations, the reference generative machine learning model can have a different network architecture from the target generative machine learning model 102.

As a particular example, when the target generative machine learning model 102 is pretrained (e.g., prior to training to perform the machine learning task by the training system 100), the reference generative model can be an instance of the pretrained generative machine learning model 102 (e.g., instance of the generative machine learning model 102 with model parameters fixed to be the initial, pretrained model parameters of the model 102).

The score prediction system 108 can be configured to process the example prompt for each training example to predict an expected quality score of data items generated by the reference generative machine learning model processing the prompt for the training example.

The score prediction system 108 can be a machine learning model with any appropriate architecture for processing the example prompts for the training examples 106 to generate expected quality scores 112 for the training examples 106. In particular, the score prediction system 108 can be a neural network that includes any of a variety of processing layers (e.g., feed-forward layers, convolutional layers, recurrent layers, attention layers, graph processing layers, and etc.) in any appropriate combination for processing the example prompts for the training examples 106 to generate expected quality scores 112 for the training examples 106.

For example, the score prediction system 108 can be a sequence processing neural network configured to generate data characterizing the expected quality scores 112 for the training examples 106 by processing input sequences (e.g., input token sequences) representing the example prompts for the training examples. As a further example, the score prediction system 108 can include an auto-regressive generative model (e.g., a Transformer, a recurrent neural network, etc.) that can process the example prompt for each training example 106 to generate an embedding (e.g., a token) representing an output expected quality score for the training example. The score prediction system 108 can process the embeddings representing the expected quality scores 112 using an output layer (e.g., an output layer that includes one or more feed-forward layers) configured to output scalar numerical values to generate the expected quality scores 112 for the training examples 106.

The update system 110 can train the generative machine learning model 102 by generating model updates 114 for the generative machine learning model 102 based on the expected quality scores 112 for the training examples and output likelihoods 116 of the example data items for the training examples determined by processing the example prompts for the training examples using the generative machine learning model 102.

In particular, the update system 110 can generate the model updates 114 for the generative machine learning model 102 to optimize an objective function that measures, for each training example, (i) the likelihood of the generative machine learning model 102 generating the example data item for the training example by processing the example prompt for the training example and (ii) a difference between the quality score for the training example and the expected quality score for the training example generated by the score prediction system 108.

In some implementations, the objective function can include a regularization loss that measures, for each training example, a difference between a distribution of data items determined by the generative machine learning model 102 processing the example prompt for the training example and a regularization distribution 118 of data items given the example prompt for the training example. The update system 110 can determine the regularization loss based on regularization likelihoods 120 of the example data items for the training examples 106 from the regularization distribution 118.

The regularization distribution of data items given the example prompt for a training example can be a distribution of data items generated by another, regularization generative machine learning model processing the example prompt for the training example. The reference generative machine learning model can have any appropriate architecture for processing the example prompts to generate data items for the machine learning task. In some implementations, the regularization generative machine learning model can have a same network architecture as the target generative machine learning model 102. In other implementations, the regularization generative machine learning model can have a different network architecture from the target generative machine learning model 102. As a particular example, the regularization generative machine learning model can be the reference generative machine learning model for which the score prediction system 108 predicts the expected quality scores 112.

By training the generative machine learning model 102 using such a regularization loss, the training system 100 can train (e.g., fine-tune) the model 102 while encouraging the model 102 to produce similar outputs compared to the regularization distribution. For example, when the regularization distribution is defined by the reference generative model and when the reference generative model is an instance of the pre-trained model 102, using the regularization loss can enable the training system 100 to train the model 102 to better perform the machine learning task without losing pre-trained capabilities of the model 102.

When the score prediction system 108 is a machine learning model, the update system 110 can train the score prediction system 108 to generate the expected quality scores 112 by generating model updates 114 for the score prediction system 108. For example, the update system 110 can jointly train the generative machine learning model 102 and the score prediction system 108 by generating the model updates 114 to optimize a shared objective function that depends on parameters of the generative machine learning model 102 and on parameters of the score prediction system 108.

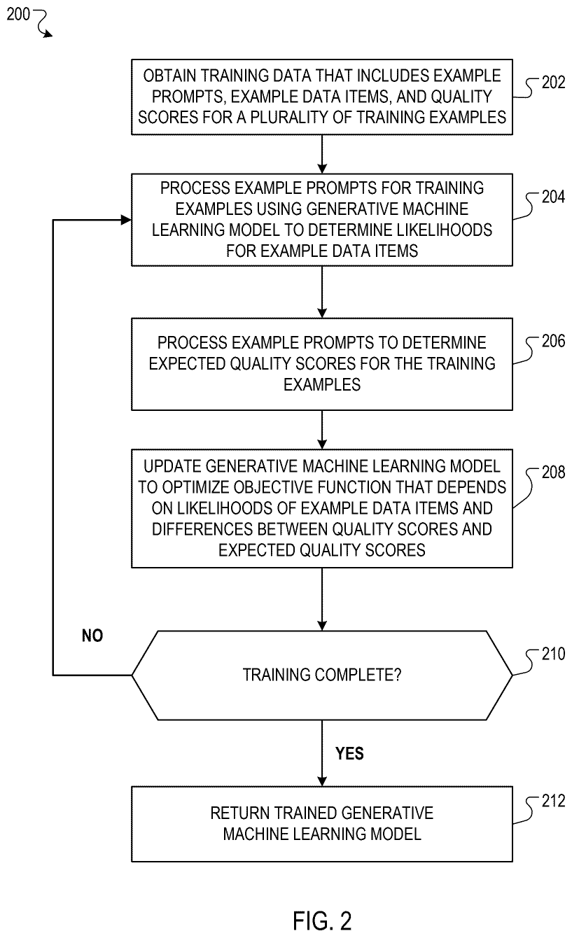

An example process and example objective functions the training system 100 can use to train the generative machine learning model 102 are described in more detail below with reference to FIG. 2.

When the quality scores for the training examples 106 characterize human feedback for the example data items, the training system 100 can therefore efficiently train (e.g., align or fine-tune) the generative machine learning model 102 to perform the machine learning task based on human feedback. In particular, because the training system 100 can train the model 102 using training examples that include individual example data items and corresponding quality scores, the system 100 can use fewer resources (e.g., training time, memory, etc.) to process each training example as part of training the model 102, e.g., as compared to the resources required to process training examples of conventional pair-wise preference data. Further, because direct feedback for individual data items can often be more easily obtained than pair-wise preference data comparing pairs of example data items, the training system 100 can train the model 102 to perform machine learning tasks for which pair-wise preference data may be impractical to obtain or to attain better performance in machine learning tasks for which a limited amount of pair-wise preference data is available (e.g., by training the model 102 using a larger training set of more easily obtained training examples).

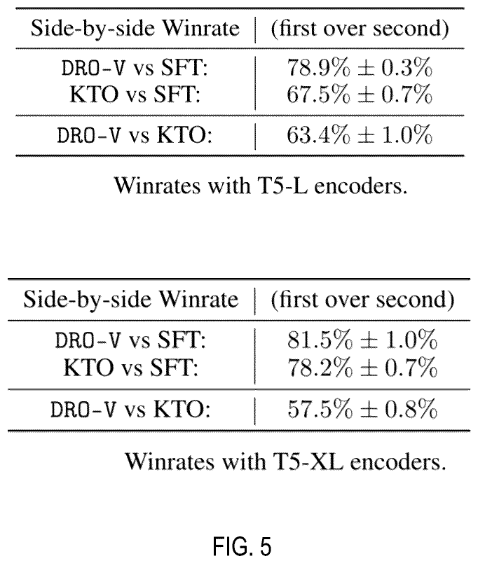

In general, the training system 100 can use an objective function that does not rely on assumptions regarding risk aversion or utility functions for human feedback to train the generative model. By not requiring assumptions regarding risk aversion or utility functions, the training system 100 can perform less biased training of the model 102 compared to existing training techniques. As illustrated below in FIG. 5, this can enable the training system 100 to train the generative model 102 to attain better performance in the machine learning task as compared to existing training techniques.

After training by the training system 100, the generative machine learning model 102 can be used to perform the machine learning task by receiving and processing input prompts for the task (e.g., from a user, another system, etc.) to generate output data items for the task.

Example machine learning tasks and example architectures for the generative machine learning model 102 are described below.

In some implementations, the machine learning task can include processing an input prompt to generate an output data item. The input prompt and the output data item can include any of a variety of modalities of data, e.g., text data, image data, audio data, structured numerical data, and so on. In some implementations, the input prompt and/or the output data item can include multi-modal data, e.g., data for multiple different modalities. The quality scores for the output data items can characterize a quality or a perceived quality of the output data items. For example, the quality scores for the data items can characterize, e.g., perceptual scores for the data items, human feedback regarding the data items, and so on. As another example, the output data items can be used as part of performing a downstream task and the quality scores for the data items can be performance metrics for the downstream task as attained using the output data items.

In some implementations, the machine learning task can be a reinforcement learning task that involves controlling an agent to perform one or more agent tasks while interacting with an environment. In the context of reinforcement learning, the generative machine learning model 102 can be considered to be a policy for the agent, the prompts for the machine learning task can include observations of an environment of an agent and the output data items for the machine learning task can characterize actions for the agent to perform the agent's tasks. The quality scores for the output data items can be rewards associated with performance of the agent tasks by the agent.

As described above with reference to FIG. 1, the generative machine learning model 102 can be a language model or vision language model neural network. In general, a (vision) language model neural network can be a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data. The (vision) language model neural network can be an autoregressive Transformer neural network.

A (vision) language model neural network can be made to perform a particular task by providing a natural language description of the desired response as an input or “prompt” (input sequence). In some cases, the prompt can be a few-shot prompt where a few, e.g., 1 to 10, examples of a query and an example output are provided in the text prior to the actual query.

A (vision) language model neural network can be “fine-tuned” to perform a particular task, by obtaining a pre-trained language model neural network trained on a large corpus of examples as previously described and then further training part of all of the language model neural network on a relatively small number of examples particular to the type of task that is to be performed.

The generative machine learning model 102 can be a large language model neural network, e.g., one that has greater than 1 billion, 10 billion or 100 billion trained parameters. The generative machine learning model 102 can have been trained on greater than 10 billion, 100 billion or 1000 billion words or tokens representing words or other tokens.

The model inputs and the model outputs can be sequences of elements referred to herein as tokens. A “token” as used in this specification is a vector of numerical values having a specified dimensionality, i.e., the number of numerical values is constant across different tokens. Each token can include a respective predetermined or learned embedding (an ordered collection of numerical values having a pre-determined dimensionality.

In some implementations, the model inputs and the model outputs can include tokens representing text, e.g., words, wordpieces or characters, in a natural or computer language. For example, text can be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language can be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens can be converted into audio data that represent speech corresponding to the text.

In some implementations, the model inputs and the model outputs can include image tokens representing images. Each image token can include a block encoding of values of the pixels in a different region of an image that maps a set of values of the pixels to a respective image token. The block encoding can be obtained using a neural network such as a Transformer neural network.

As used herein an image can be any still or moving image, i.e., the image can be part of a video, in 2D or 3D, and can be a monochrome, color or hyperspectral image, i.e., including monochrome or color pixels. As defined herein an “image” includes a point cloud, e.g., from a LIDAR system, and a “pixel” includes a point of the point cloud. An image can be captured by a camera or other image sensor from the real world; and objects in the image can include physical objects, represented by the image.

In some implementations, the model inputs and the model outputs can include tokens representing audio waveforms. For example, a set (sequence) of input or output tokens can represent audio data representing a waveform e.g., instantaneous audio amplitude values or time-frequency audio data. Each audio token can include a block encoding of the audio waveform in a different time segment of the audio that maps a set of values representing the audio waveform to a respective image token. The block encoding can be obtained using a neural network such as a Transformer neural network.

In a multimodal system audio data or an image can be flagged by a start-of-audio token or start-of-image token.

In some implementations the model inputs can include tokens representing text, pixels of an image, or an audio waveform and the generative machine learning model 102 can generate the output sequence of tokens to perform tasks represented by the input sequence of tokens.

In some implementations the machine learning task can include an image or audio generation task. The input sequences of tokens can then characterize images or audio to be generated, and the output sequences of tokens can include tokens defining images or audio waveforms characterized by the input sequences of tokens, e.g., text tokens.

In some implementations the machine learning task can include an image or audio processing task. The input sequences of tokens can define image or audio inputs, and the output sequences of tokens can include tokens defining text that describes the image or audio inputs. As some examples, the machine learning task can include a speech recognition task, an object or action detection task, a classification task, a captioning task, a question-answering task, or a character or word recognition task.

In some implementations the machine learning task can include a multimodal processing task in which the input sequences of tokens and/or the output sequences of tokens can include multimodal data. For example, an input sequence of tokens can characterize both an image or audio input and a text input and a corresponding output sequence of tokens can include tokens defining a result of an image or audio processing task defined by the text, such as an open vocabulary classification or object detection task.

In general, multimodal data includes a combination of two or more different types of data, e.g., two or more of audio data, image data, text data, or graph data. As one example the multimodal data can include audio-visual data, comprising a combination of pixels of an image or of video and audio data representing values of a digitized audio waveform. As another example the multimodal data can include a combination of i) text data representing text in a natural language and ii) pixels of an image or of video or audio data representing values of an audio waveform.

Some examples of multimodal tasks include: open-vocabulary image classification (the output can classify the image input based on a text input comprising text descriptions of one or more classes in the image); open-vocabulary object detection (the output can detect one or more objects in the image input based on a text input comprising text descriptions of the one or more objects); image captioning (the output can comprise text that describes the image input); text-based image search (the output can identify from amongst multiple images in the image input one or more images that meet a text description of images to be retrieved, the text description being provided in a text input); image-based retrieval (the output can identify from amongst multiple images in the image input one or more images that match a further image in the image input), and so on. The multimodal processing tasks to be performed can be defined by text in the input sequences.

In some implementations the machine learning task can include an agent control task in which the agent interacts with an environment to perform the task. The agent can be a mechanical agent such as a robot or (semi-) autonomous vehicle, interacting with a real-world environment to perform the task. The generative machine learning model 102 can be trained to control a simulated version of the agent in in a simulated version of the environment and then afterwards used to control the real agent in the real-world environment. The input sequence of tokens can include tokens that represent an observation of the environment, e.g., an image captured by a camera or other imaging device from a real-world environment. The output sequences of tokens comprises tokens that define one or more actions to be performed by the agent in the environment in response to the observation.

In some implementations the generative machine learning model 102 can be stored on a user computing device, i.e., a device local to the user, such as a mobile device, e.g., a mobile phone, or a smart speaker.

In some implementations the generative machine learning model 102 can be implemented on a remove server in communication with a user computing device over a wired or wireless network communications link between the user computing device and the server.

The user computing device can be provided with an input mechanism, such as a text or voice interface, that enables user input from the user in a natural language. The user computing device can be provided with an output mechanism that provides a system output for the user in the or another natural language, e.g., as speech or text; or in some other way, e.g., by displaying an image. The input and output mechanisms can include, e.g., a keyboard, microphone, speaker, display, and/or camera.

As an example, the input mechanism can include a system configured to input audio data characterizing a speech waveform of speech representing the input from the user in a natural language, and a system configured to convert the audio data into tokens representing the speech in the natural language, e.g., representing a transcription of the spoken input. The output mechanism can include a system configured to receive tokens representing the output for the user in the or another natural language and a system configured to convert the received tokens into audio data representing a waveform of speech representing the output to the user in the natural language, i.e., representing spoken words.

As a further example, the generative machine learning model 102 can be deployed in an environment that enables a user to provide a request for the system, e.g., to process a multimodal input to generate a corresponding output sequence output. Users can provide requests, e.g., by way of a user interface or through an application programming interface (API). The request can be transmitted from a user device, e.g., over a data communications network such as the internet, to one or more computers implementing the system, e.g., in a data center. The system can generate a output sequence and then transmit the output sequence to a user device over a data communications network.

A user computing device can be provided, as an interface for the generative machine learning model 102, with an input mechanism that enables user input from the user in a natural language and an output mechanism that provides a system output to the user in the natural language. The input and output mechanism can include, e.g., a keyboard and display. Also or instead the input and output mechanism can include a speech-based mechanism. For example, the input mechanism can include a system configured to input audio data characterizing a speech waveform of speech representing the input from the user in the natural language and configured to convert the audio data into tokens representing the speech in the natural language, e.g., representing a transcription of the spoken input. The output mechanism can include a system configured to receive tokens representing the output to the user in the natural language and a system configured to convert the received tokens into audio data representing a waveform of speech representing the output to the user in the natural language, i.e., representing spoken words.

In some implementations the input sequences include one or more natural language statements relating to an environment, in particular a real-world environment, and include natural language requests relating to the environment. Similarly the output sequences can include natural language replies or natural language output statements that also relate to the environment, i.e., providing information relating to the environment, in some implementations relating to or specifying actions to be taken in the environment.

The generative machine learning model 102 can be used for diagnosing faults, or for correcting undesired behavior, in a mechanical or computing system operating in the real world environment. The model inputs can include descriptions and/or images of observations of the mechanical or computing system, e.g., of operation of the system, optionally obtained from one or more sensors sensing a condition or operation of the system. An image observation can be converted into a text description, e.g., using an image captioning system or in other ways. The generated output sequences may include images, audio, or text that identify (describe) likely causes of the faults or undesired behavior. This can be used to repair the faults or correct the behavior. The preference measures for the machine learning task can define relatively more useful types of output for repairing faults or correcting behavior, and other aspects of the responses as previously described.

The generative machine learning model 102 can be used for controlling a mechanical agent such as a robot or vehicle. For example, the model inputs can include descriptions of tasks to be performed, and the generated output sequences can include lists of sub-tasks to be performed by the mechanical agent (trained to perform such sub-tasks), in order to perform the tasks. The preference measures for the machine learning task can define relatively more preferable or useful types of sub-task, task safety, efficiency, and so on.

As another example, the environment can be a computer security monitoring environment, e.g., the system can be deployed as part of a system that monitors the security of one or more computers. For example, the environment can be a computer network security monitoring environment, and the system can be deployed as part of a system that monitors the security of one or more computers on a computer network, e.g., a wireless network, a cellular network, a local area network and/or the internet. As another example, the environment can alternatively or additionally be a computer system security monitoring environment and the system can be deployed as part of a system that monitors the system for the presence of computer viruses and/or an unresolved software vulnerability, e.g., a zero-day exploit. A software vulnerability can be resolved by updating the software (e.g., patching) and/or removing (e.g., uninstalling) the software from the computer system. In these examples, the natural language requests can query whether computer security incidents have been resolved (e.g., “has the incident been resolved?”) and the model inputs can include relevant statements from system logs, i.e., that are potentially relevant to the events being queried. A computer security incident can be, e.g., a data breach, an unauthorized log-in or other access of a secured system, a detection of a computer virus or detection of a software vulnerability. An incident can be “resolved” when the underlying incident is no longer a threat to the security of the computer system e.g., the computer virus has been removed, the access to the secured system has been removed, the data breach has been mitigated, or the software having the vulnerability has been updated or removed. The system can use the model inputs 204 to generate replies to the requests that include natural language statements indicating whether the incidents have been resolved, optionally displaying evidence used to determine this.

The model inputs can include one or more of: code snippets from the software code, system logs, program logs, or other artifacts that should be left on the computer by running the program, or verification rules that represent requirements for the execution of the software program, or natural language statements describing the computer system on which the software executes. In general, the model inputs can include relevant statements, i.e., statements that are potentially relevant to the events being queried.

In some implementations obtaining input data from the environment can include obtaining, from the system logs, the data characterizing the computer network, or both, or from other data as described above, one or more observations of the computer network (which here includes computers on the network), and processing the one or more observations to generate a natural language representation of the one or more observations. The natural language requests can relate to the computer security incidents or to the secure operation of the computer network. The machine learning task can include using the natural language representations of the one or more observations to provide one or more of the natural language statements describing the computer network, and using the natural language replies or the natural language output statements to identify a security status of the computer network or a security flaw in the computer network.

As another example, the environment can be a software testing or evaluation environment, e.g., the system can be deployed as part of a system that tests software before deployment or that evaluates already-deployed software to identify bugs. In these examples, when the system tests software before deployment, the natural language requests can ask whether the software will execute as intended, and the model inputs can include code snippets from the software code and, optionally, natural language statements describing the computer system on which the software will execute. The generative machine learning model 102 can process the model inputs to generate replies that indicate whether the code will execute as intended, optionally displaying evidence used to determine this. When the system monitors the execution of code after deployment, the natural language requests can ask whether a software program, or a portion of a software program, has executed as intended, and the model inputs can include one or more of: code snippets from the software code, system logs, program logs, or other artifacts that should be left on the computer by running the program, or verification rules that represent requirements for the execution of the software program, or natural language statements describing the computer system on which the software executes. The model 102 can then process the model inputs to generate replies that indicate whether the code has executed as intended, optionally displaying evidence used to determine this. As a particular example, the software program can be part of the boot up of a computer, and the model 102 can generate a reply each time that the computer starts up to verify whether the computer will function correctly after start up.

As another example, the environment can be an educational environment, e.g., the system can be deployed as part of an education software program that assists a user in learning or practicing one or more corresponding skills. In these examples, the model inputs can include natural language statements describing or referencing a scenario or scene in a real-world or imagined environment, and the requests can be questions about the scenario or scene.

As another example, the environment can be an information retrieval environment, e.g., the system can be deployed as part of a search engine or other software that allows a user to search for information in a corpus of documents, e.g., the Internet or another electronic document corpus. In these examples, the requests can be any appropriate natural language question, and the replies can optionally include evidence such as include relevant statements from the corpus of documents, e.g., as identified by searching the corpus using conventional information retrieval techniques.

In some implementations, the generative machine learning model 102 is a visual language model (VLM). In general, the VLM can process input sequences that include tokens that each represent natural language or (a part of) an image or video to generate output tokens that each represent natural language or (a part of) an image or video. For example, the VLM can be configured to describe an image or video using natural language, e.g., to perform an image or video captioning task. As another example, the VLM can be configured to process input tokens representing an image and text tokens representing a query about the image or a request to modifying the image, and to generate output tokens representing an answer to the query or representing a version of the image that has been modified in accordance with the request. The VLM can generate output tokens representing an image or video that is generated in response to input tokens providing a visual and/or audio and/or textual description of a desired image or video.

In some implementations, the “language” of the language model is not a natural language such (e.g., English), but can instead be a text-based encoding describing an entity or class of entities, e.g., a chemical or biological entity, such as a chemical structure or molecule. For example, the text-based encoding can be a sequence of tokens that defines a molecule or protein, e.g., a sequence specifying an arrangement of atoms or chemical functional groups in a molecule, or the amino acid residues of a protein. The language model can be referred to as a chemical and/or biological language model in such cases. The model inputs therefore be input strings defining chemical (e.g., protein) structures and the model outputs can include output strings defining different chemical structures from the input strings. The strings can be in the Simplified Molecular Input Line Entry System, SMILES, format, for example.

In another example of a computer language text generation task, a model input can include an image or video and a sequence of text in a computer language for performing a task in relation to the image or video, e.g., a data processing task that involves analyzing the content of the image or video to provide a result of the analysis or, e.g., a search to search for information relating to the content of the image or video. The computer language in the model output can include computer language for invoking a function or calling one or more external APIs. Merely as one example, such an output can be formatted as a JSON object. As previously, the sequence of text in a multimodal input can define the task to be performed and the second modality input can include, e.g., an image or video in relation to which the task is to be performed, e.g., a task that involves manipulation of particular types of data that may benefit from access to an API such as mathematical data, date/time related data, scientific data, recent data that may post-date training of the model (that can be accessed by a search function or API), and so on. After training, when the model is used in inference, the model output can include text in the or another computer language for performing a task, e.g., as described above, in relation to an image or video in the second modality input. The machine learning task can then include using the text in the computer language to perform the task.

In some implementations, the generative machine learning model 102 can be used to interact with a human user of a digital assistant such as a smart speaker, smart display, or other device. For example, information defining a task can be obtained from the digital assistant, and the digital assistant can be used to instruct the user to perform the task. For example, this can include receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This can be done using natural language, e.g., on a display and/or using a speech synthesis subsystem of the digital assistant. Visual, e.g., video, and/or audio observations of the user performing the task can be captured, e.g., using the digital assistant. A system can then be used to determine whether the user has successfully achieved the task, e.g., step or sub-task, i.e., from the answer as previously described. If there are further tasks to be completed the digital assistant can then, in response, progress to the next task (if any) of the series of tasks, e.g., by outputting an indication of the next task to be performed. In this way the user can be led step-by-step through a series of tasks to perform an overall task.

As an illustrative example, a user can be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses model 102 as described above, in particular by providing it with the captured audio and/or video and a question that asks whether the user has completed a particular step, e.g., ‘Has the user finished chopping the peppers?’, to determine whether the user has successfully completed the step. If the answer confirms that the user has successfully completed the step then the digital assistant progresses to telling the user to perform the next step or, if at the end of the task, or if the overall task is a single-step task, then the digital assistant may indicate this to the user. The digital assistant can then stop receiving or processing audio and/or video inputs to ensure privacy and/or reduce power use.

The digital assistant can also include a user interface to enable a user to request assistance and to output information. In implementations this is a natural language user interface and can include a keyboard, voice input-output subsystem, and/or a display. The digital assistant can further include an assistance subsystem configured to determine, in response to the request, a series of tasks for the user to perform. In implementations this can include a generative (large) language model, in particular for dialog. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g., of a series of tasks, e.g., until a final task of the series. More particularly, the assistance control subsystem can output to the user an indication of the task to be performed, capture, using the observation capture subsystem, visual or audio observations of the user performing the task, determine from the above-described answer whether the user has successfully achieved the task. In response, the digital assistant can progress to a next task of the series of tasks and/or control the digital assistant, e.g., to stop capturing observations.

In some implementations, a particular task that is to be performed by the generative machine learning model 102 can be described by part or all of a sequence of text in an input to the model 102. For example, in a model input that includes an image such a prompt can specify, e.g., “Generate a caption”, “Generate a description”, “Answer the following question: [about the image or video]”, or “Detect a person”. Where the model 102 is used for an agent control task a prompt can define, e.g., “Take the knife out of the drawer”, or “Q: What action should the robot take to take the knife out of the drawer?”. Also or instead such a prompt can give one or more examples of a task to be performed. The model 102 can be trained on multiple natural and/or computer languages and the prompt may then specify a language to use.

A few further examples of some machine learning tasks that can be performed by a generative machine learning model 102 trained as described herein follow. The tasks described below can include tasks that require spatial awareness or other context from input images or video. For example, a prompt may ask “What is the object in the top left corner?”.

In general, for the tasks below the model 102 can have been trained or fine-tuned on examples of the input and output for the task. For example, the model 102 can have been trained using still or moving images containing one or more objects or actions, and corresponding sequences of text or other data e.g., describing or classifying the images. However large, “foundation” models can, in general, perform some tasks zero-shot, i.e., without having been specifically trained on those tasks.

As one example the task can include an object or action detection task. For example, a generated output sequence can include or represent text that describes or otherwise labels detected object(s) or action(s) in an input that includes an image or audio, and can include coordinates such as bounding-box coordinates for the detected object(s) or action(s), e.g., “10 20 90 100 cat 20 30 100 100 dog”.

As another example the task can include a classification task, e.g., an object or action classification task. A generated output sequence can include data, e.g., text, that classifies the object(s) or action(s) in represented in conditioning data, e.g., in an image or audio, into one of a plurality of classes, or that otherwise classify object(s) or action(s) represented in the conditioning data.

As another example the task can include a still or moving image describing task, e.g., a captioning task (which, as used here, includes an audio description task to explain what is happening in an image). A generated output sequence can include data, e.g., text, describing an input image or video. For example, a generated output sequence can provide a caption or description or it can count objects in the image or video, or it can provide some other form of description.

As another example the task can include a still or moving image question-answering task. A generated output sequence can include data, e.g., text, that answers a question about an input, e.g., an input image or audio, where the question is also specified in the input, e.g., as sequence of text. This may be used, e.g., to answer questions about visual plots and charts or about sounds.

As another example the task can include a character or word recognition task, e.g., an OCR (optical character recognition) task. An input can include a still or moving image and a generated output sequence can include text that represents characters or words in the input, e.g., in a natural language.

As another example the task can include a still or moving image generation task. A generated output sequence can include image data defining values for pixels of a still or moving image, and an input, e.g., a sequence of text, may describe or characterize the image to be generated. Merely as an example, an image of a plot or chart can be generated to represent the input, e.g., comprising text.

As another example the task can include a computer language text generation task. An input can include a natural language description of a task to be performed, and optionally an image (if the task is to be performed on or in relation to an image), and a generated output sequence can include text in a computer language to perform the task, e.g., a task of analyzing the content of the image to provide a result of the analysis or to search for information relating to the content of the image.

As a particular example the computer language in a generated output sequence can include computer language for invoking a function or calling one or more external APIs. Merely as one example, such an output sequence can include data formatted as a JSON object. As previously, an input can define a task to be performed and can also include an image in relation to which the task is to be performed. In general the task can involves manipulation of particular types of data that can benefit from access to an API such as mathematical data, date/time related data, scientific data, recent data that may post-date training of the model 102 (that can be accessed by a search function or API), and so on; and the generated output sequence can include text in a computer language for performing the task. The machine learning task can include using the text in the computer language to perform the task.

In general where a generated output sequence includes text, such text can be converted to speech representing the text, and an audio (speech) output provided.

In some implementations the task can include an agent control task in which the agent interacts with an environment to perform the agent control task. In these implementations an input can include an observation characterizing the environment. For example, an input can include a sequence of text that defines a task to be performed by the agent and an image representing an observation of the environment, e.g., captured by a camera or other imaging device from a real-world environment. A generated output sequence can include an action selection output, e.g., including text, that is used to select one or more actions to be performed by the agent in the environment in response to the observation. As an illustration the generated output sequence can define an action as text such as “A: 132 114 128 5 25 156”, that can be converted into a control signal for a mechanical agent, such as a robot, e.g., “ΔT=[0.1,−0.2,0] ΔR=[10°, 25°,−7°]”. The action selection output can also or instead define one or more low-level skills, e.g., from a vocabulary of previously learnt skills. As before, a sequence of text in a model input can describe the task to be performed, e.g., “What action should the robot take to [perform task]”. Examples of systems for controlling an agent that can be fine tuned as described herein can include PaLM-E (Driess, et al., arXiv: 2303.03378), RT-1 (Brohan, et al., arXiv: 2212.06817), and RT-2 (Brohan, et al., arXiv: 2307.15818).

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent can be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations can include, e.g., one or more of: images, object position data, and sensor data to capture observations as the agent interacts with the environment. The actions can define control signals to control the robot or other mechanical agent, e.g., positions, torques, or other control signals for the parts of the mechanical agent, or higher-level control commands.

In some agent control implementations the agent can be a human agent and the environment can be a real-world environment. For example, the agent can be a human user of a digital assistant such as a smart speaker, smart display, or some other device that is used to instruct the user to perform actions. The task can include any real-world task that the user wishes to perform. The observations can be obtained from an observation capture subsystem, e.g., a monitoring system such as a video camera or sound capture system, to capture visual observations of the user performing the task. The actions can include instructions in the form of, e.g., text, image, video, or audio data such as speech, that guide the user in performing the task.

The described systems and techniques can be applied to a wide range of different types of input sequences and output sequences. In implementations of the described techniques the tokens can represent, characterize, or encode any type of information in a sequence, e.g., stream of data. The term “represent” is used, below, generally to refer to any way in which a token can encode part of a sequence. The tokens may include marker tokens, such as a start of sequence token, an end of sequence token, and a separator token (indicating a separation or break between two distinct parts of a sequence). The tokens may, but need not be, drawn from a defined vocabulary of tokens.

Some of these implementations can be used for natural language tasks such as providing a natural language response to a natural language input, e.g., for question answering, or for text completion. In some implementations the input sequence can represent text in a natural language and the output sequence may represent text in the same natural language, e.g., a longer item of text. For example, in some implementations the input sequence can represent text in a natural language and the output sequence may represent the same text with a missing portion of the text added or filled in. For example, the output sequence can represent a predicted completion of text represented by the input sequence. Such an application can be used, e.g., to provide an auto-completion function, e.g., for natural language-based search. In some implementations the input sequence can represent a text in a natural language, e.g., posing a question or defining a topic, and the output sequence can represent a text in a natural language which is a response to the question or about the specified topic.

As another example the input sequence can represent a first item of text and the output sequence can represent a second, shorter item of text, e.g., the second item of text can be a summary of a passage that is the first item of text. As another example the input sequence can represent a first item of text and the output sequence can represent an aspect of the first item of text, e.g., it can represent an entailment task, a paraphrase task, a textual similarity task, a sentiment analysis task, a sentence completion task, a grammaticality task, and in general any natural language understanding task that operates on a sequence of text in some natural language, e.g., to generate an output that classifies or predicts some property of the text. For example, some implementations can be used to identify a natural language of the first item of text, or of spoken words where the input is audio (as described below).

Some implementations can be used to perform neural machine translation. Thus in some implementations the input tokens can represent words, wordpieces, or characters in a first natural language and the output tokens can represent words, wordpieces or characters in a second, different natural language. That is, the input sequence can represent input text in the first language and the output sequence can represent a translation of the input text into the second language.

Some implementations can be used for automatic code generation. For example, the input tokens can represent words, wordpieces or characters in a first natural language and the output tokens can represent instructions in a computer programming or markup language, or instructions for controlling an application program to perform a task, e.g., build a data item such as an image or web page.

Some implementations can be used for speech recognition. In such applications the input sequence can represent spoken words and the output sequence can represent a conversion of the spoken words to a machine-written representation, e.g., text. Then the input tokens can include tokens representing an audio data input including the spoken words, e.g., characterizing a waveform of the audio in the time domain or in the time-frequency domain. The output tokens can represent words, wordpieces, characters, or graphemes of a machine-written, e.g., text, representation of the spoken input, that is representing a transcription of the spoken input.

Some implementations can be used for handwriting recognition. In such applications the input sequence can represent handwritten words, syllabograms or characters and the output sequence may represent a conversion of the input sequence to a machine-written representation, e.g., text. Then the input tokens can include tokens representing portions of the handwriting and the output tokens can represent words, wordpieces, characters or graphemes of a machine-written, e.g., text, representation of the spoken input.

Some implementations can be used for text-to-speech conversion. In such applications the input sequence can represent text and the output sequence can represent a conversion of the text to spoken words. Then the input tokens can include tokens representing words or wordpieces or graphemes of the text and the output tokens can represent portions of audio data for generating speech corresponding to the text, e.g., tokens characterizing a portion of a waveform of the speech in the time domain or in the time-frequency domain, or phonemes.

Some implementations can be used for a genomics task, where the input sequence represents a fragment of a DNA sequence or other molecule sequence and the output sequence is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the model 102 can be configured to perform multiple different individual machine learning tasks, e.g., two or more of the machine learning tasks mentioned above. For example, the model 102 can be configured to perform multiple individual natural language understanding tasks, with the model inputs including an identifier for the individual natural language understanding task to be performed on the model inputs.

In some implementations the input sequence and the output sequence represent different modalities of input. For example, the input sequence can represent text in a natural language and the output sequence can represent an image or video corresponding to the text; or vice-versa. In general, the tokens can represent image or video features and a sequence of such tokens can represent an image or video. There are many ways to represent an image (or video) using tokens. As one example an image (or video) can be represented as a sequence of regions of interest (RoIs) in the image, optionally including one or more tokens for global image features. For example, an image can be encoded using a neural network to extract RoI features; optionally (but not essentially) a token can also include data, e.g., a position encoding, representing a position of the RoI in the image. As another example, the tokens can encode color or intensity values for pixels of an image. As another example, some image processing neural network systems, e.g., autoregressive systems, naturally represent images as sequences of image features. As another example, a transformer-based sequence processing neural network system as previously described can be used to process images instead of or as well as text (e.g., if trained on images instead of or as well as text).

Thus in some implementations at least one of the input sequence and the output sequence is a sequence representing an image or video and can include tokens representing the image or video. For example, the input sequence can be a sequence of text, the input tokens can represent words, wordpieces, or characters and the output sequence can include output tokens representing an image or video, e.g., described by the text, or providing a visual answer to a question posed by the text, or providing a visualization of a topic of the text. In another example the input sequence can include a sequence of input tokens representing an image or video, and the output tokens can represent words or wordpieces, or characters representing text, e.g., for a description or characterization of the image or video, or providing an answer to a question posed visually by the image or video, or providing information on a topic of the image or video.

In some other implementations both the input sequence and the output sequence can represent an image or video, and both the input tokens and the output tokens can represent a respective image or video. In such implementations the method/system can be configured to perform an image or video transformation. For example, the input sequence and the output sequence can represent the same image or video in different styles, e.g., one as an image the other as a sketch of the image; or different styles for the same item of clothing.

In some implementations the input sequence represents data to be compressed, e.g., image data, text data, audio data, or any other type of data; and the output sequence a compressed version of the data. The input and output tokens can each include any representation of the data to be compressed/compressed data, e.g., symbols or embeddings generated/decoded by a respective neural network.

In some implementations the input sequence represents a sequence of actions to be performed by an agent, e.g., a mechanical agent in a real-world environment implementing the actions to perform a mechanical task. The output sequence can include a modified sequence of actions, e.g., one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence can include a sequence of predicted treatment. Then the input tokens can represent any aspect of the health of a patient, e.g., data from blood and other medical tests on the patient and/or EHR (Electronic Health Record) data; and the output tokens can represent diagnostic information, e.g., relating to a disease status of the patient and/or relating to suggested treatments for the patient, and/or relating to a likelihood of an adverse health event for the patient.

As a particular example the model 102 can be a multimodal model neural network in which one or both of the model input (i.e., input sequence) and the model output (i.e., output sequence) include an image or audio. For example the multimodal machine learning model can be configured to process an input sequence including visual tokens representing pixels of a still or moving image (which here may include a point cloud image), and/or data representing an audio waveform, e.g., values or features of the audio waveform such as audio tokens, and/or text tokens representing a sequence of text, to generate an output sequence, e.g., including text tokens representing the still or moving image or audio waveform, and/or a sequence of intensity value inputs for the pixels of an image or a sequence of values defining an audio waveform. A visual token can, e.g., represent multiple pixels in a region of the image, e.g., as features of the region. Such a multimodal model 102 can perform any of the previously described tasks, e.g., using a multimodal input, or by providing a multimodal output, or by converting between different input and output modes (e.g., text/image/audio). For example, it can generate text representing, describing (e.g., captioning), or otherwise characterizing an image or audio input, e.g., by answering a question related to the image or audio input, e.g., relating to a future, e.g., physical prediction of a state of objects represented by the image or audio. As another example it can generate an image or audio represented, described, or otherwise characterized by a text input, or otherwise in response to the text input, e.g., representing an image or audio answer to a text question.

FIG. 2 is a flow diagram of an example process 200 for training a target generative model to perform a machine learning task. For convenience, the process 200 will be described as being performed by a system of one or more computers located in one or more locations. For example, a training system, e.g., the training system 100 of FIG. 1, appropriately programmed in accordance with this specification, can perform the process 200.

The system can obtain training data for the machine learning task that includes a plurality of training examples (step 202). Each training example can include an example prompt for the training example, an example data item for the training example, and a quality score for the training example that measures a quality of the example data item for the training example.

As described above, the example prompts and the example data items can include any of a variety of modalities of data, e.g., text data, image data, audio data, structured numerical data, and so on. In some implementations, the example prompts and/or the example data items can include multi-modal data, e.g., data for multiple different modalities.

The quality scores for the example data items can characterize a quality or a perceived quality of the example data items. For example, the quality scores for the example data items can characterize, e.g., perceptual scores for the data items, human feedback regarding the example data items, and so on. As another example, the example data items can be used as part of performing a downstream task and the quality scores for the example data items can be performance metrics for the downstream task as attained using the example data items.

In some implementations, the machine learning task can involve interacting with a user to perform the task, e.g., by generating responses to queries received from the user. When the machine learning task involves interacting with a user, the example prompt for a training example can include examples of queries from an example user and the example data item for the training example can include example responses to the examples of queries from the example user.

In some implementations, the machine learning task can be to select actions for an agent interacting with an environment to perform a task in the environment. The example data items for a training example can include example selected actions for an example agent to perform the task in an example environment for the training example. The example prompts can include example observations of the example environment for the training example.

The quality scores for the training examples can be performance measures for the machine learning task. When the machine learning task includes selecting actions for an agent interacting with an environment to perform a task in the environment, the quality scores for the training examples can be performance measures for the task in the environment.

In some implementations, the quality scores for the training examples can be generated by a preference prediction machine learning model processing the training examples. For example, the quality scores for the training examples can be generated by processing data characterizing generated data items using a language model along with a prompt requesting the language model to evaluate the generated data items.

The system can train the target machine learning model over a sequence of training iterations. As part of training the target generative machine learning model, the system can perform steps 204 through 210 at each training iteration.

For each training example for the training iteration, the system can process the example prompt for the training example using the target generative machine learning model to determine a likelihood of the target generative machine learning model generating the example data item for the training example (step 204).

The system can determine the likelihood, π_{θ}(y|x), of the target generative model generating an example data item y by processing an example prompt x by any of a variety of methods. For example, in some implementations, the target generative machine learning model can be configured to generate a model output that specifies a distribution of output data items (e.g., by specifying a mean and covariance for a distribution of output data items, by specifying logits or probabilities for a set of output data items, etc.) and the system can determine the likelihood π_{θ}(y|x) to be the likelihood of the example data item y according to a distribution of data items specified by the model output generated by the target generative machine learning model processing the example prompt x.

As another example, in some implementations, the target generative machine learning model can be configured to generate output data items for an example prompt x by sampling noise values z from a prior noise distribution, p_{z}(z), (e.g., a multi-variate Gaussian noise distribution, a multi-variate uniform noise distribution, etc.) and by then processing the sampled noise values and the example prompt to generate an output data item following a mapping defined by the target generative machine learning model, f_{θ}(z, x). When the target generative model is configured to generate output data items by transforming sampled noise, the system can determine the likelihood π_{θ}(y|x) to be a likelihood of sampling a noise value from the prior noise distribution that the target generative machine learning model maps to the example data item y (e.g., a likelihood of sampling a noise value z such that y=f_{θ}(z, x)). As a particular example, the target generative machine learning model can define an invertible transformation from noise values to data items, f_{θ}(z|x), and the system can determine π_{θ}(y|x) following:

$${π}_{θ} ( y \vert x ) = {p}_{z} ( {f}_{θ}^{- 1} ( y \vert x ) ) \vert \frac{\partial {f}_{θ}^{- 1} ( y \vert x )}{\partial y} \vert$$

Where

$${f}_{θ}^{- 1} ( y \vert x )$$

is the inverse transformation defined by the target generative machine learning model and

$$\vert \frac{\partial {f}_{θ}^{- 1} ( y \vert x )}{\partial y} \vert$$

is a determined of the Jacobian matrix of

$${f}_{θ}^{- 1} ( y \vert x ) .$$

In some implementations, the target generative machine learning model can be configured to auto-regressively generate output data items. For example, the target generative machine learning model can be configured to generate a sequence of n data items, y_{1:n}, over a sequence of auto-regressive iterations. At each auto-regressive iteration, the target generative machine learning model can process an input prompt and some or all of the data items generated at the previous auto-regressive iterations to generate an output data item for the auto-regressive iteration. When the target generative machine learning model auto-regressively generates output data items, the system can determine the likelihood, π_{θ}(y_{1:n}|x), of the target generative machine learning model generating an example sequence of data items y_{1:n} by processing an example prompt x following:

$${π}_{θ} ( {y}_{1 : n} \vert x ) = {π}_{θ} ( {y}_{1} \vert x ) {π}_{θ} ( {y}_{2} \vert {y}_{1} , x ) … {π}_{θ} ( {y}_{n} \vert {y}_{n - 1} , … , {y}_{1} , x )$$

Where π_{θ}(y₁|x) is the likelihood of the target generative machine learning model processing the example prompt x to generate the first example data item y₁, π_{θ}(y₂|y₁, x) is the likelihood of the target generative machine learning model processing the example prompt x and the first example data item y₁ to generate the second example data item y₂, and so on.

In some implementations, the system can determine the likelihood, π_{θ}(y|x), by determining a log-likelihood, log π_{θ}(y|x), or any other appropriate function of the likelihood π_{θ}(y|x).

For each training example for the training iteration, the system can process the example prompt for the training example to determine an expected quality score for the training example (step 206). The expected quality score for the training example can be an expected quality score for a reference distribution of data items for the example prompt for the training example. The reference distribution of data items for the example prompt for the training example can be a distribution of data items determined by processing the example prompt for the training example using a reference generative machine learning model.

For example, prior to the system training the target generative model, the target generative model can be pretrained to perform one or more pre-training tasks and the reference generative machine learning model can be an instance of the pre-trained model.

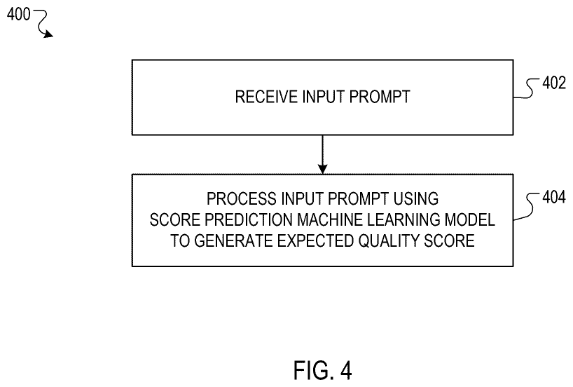

In some implementations, the system can generate the expected quality score for each training example by processing the example prompt for the training example using a score prediction machine learning model, as described in more detail below with reference to FIG. 4.

The system can update the target generative machine learning function to optimize an objective function that depends on (i) the likelihoods of the target generative machine learning model generating the example data items by processing the example prompts for the training examples and (ii) differences between the quality scores for the training examples and the corresponding expected quality scores for the training examples (step 208). In particular, the system can update parameters of the target generative machine learning model to optimize the objective function.

In some implementations, the objective function can include a regularization term that measures, for each training example, a difference between a distribution of data items determined by processing the example prompt for the training example using the target generative machine learning model and a regularization distribution of data items for the example prompt for the training example. In particular, the regularization term can measure, for each training example, a difference between (i) the likelihood of the target generative machine learning model generating the example data item by processing the example prompt for the training example and (ii) a likelihood of the example data item for the training example as determined by the regularization distribution of data items for the example prompt for the training example.

For example, in some implementations, for each training example, the objective function can measure the loss:

$$ℒ = \frac{1}{2} {( r ( x , y ) - V ( x ) - τ log \frac{{π}_{θ} ( y \vert x )}{q ( y \vert x )} )}^{2}$$

Where x is the example prompt for the training example, y is the example data item for the training example, r(x, y) is the quality score for the training example, V(x) is the expected quality score for the training example, t is a regularization weight, π_{θ}(y|x) is a likelihood of the target generative model generating the example data item for the training example by processing the example prompt for the training example, and q(y|x) is the likelihood of the example data item for the training example as determined by the regularization distribution of data items for the example prompt for the training example.

The regularization distribution of data items for the example prompt for each training example can be a distribution of data items determined by processing the example prompt for the training example using a regularization generative machine learning model. As a particular example, the regularization generative machine learning model can be the reference generative machine learning model and the objective function can measure, for each training example, the loss:

$$ℒ = \frac{1}{2} {( r ( x , y ) - V ( x ) - τ log \frac{{π}_{θ} ( y \vert x )}{{π}_{ref} ( y \vert x )} )}^{2}$$

Where π_{ref}(y|x) is a likelihood of the reference generative model generating the example data item for the training example by processing the example prompt for the training example. Importantly, by measuring such a loss for each training example, the objective function does not need to rely on assumptions regarding risk aversion or utility functions for the machine learning task.

As part of updating the parameters of the target generative machine learning model, the system can determine gradients of the objective function (e.g., gradients of the objective function with respect to the parameters of the target generative machine learning model). For example, for each training example, the system can determine the gradient of the objective function following:

$${∇}_{θ} ℒ = - τ {∇}_{θ} log {π}_{θ} ( y \vert x ) ( r ( x , y ) - V ( x ) ) + \frac{{τ}^{2}}{2} {∇}_{θ} {( log \frac{{π}_{θ} ( y \vert x )}{{π}_{ref} ( y \vert x )} )}^{2}$$

The system can update the parameters of the target generative machine learning model using the gradients of the objective function following any appropriate machine learning technique (e.g., following stochastic gradient descent, ADAM, etc.).

When the system determines the expected quality scores using a score prediction machine learning model, the system can train the score prediction machine learning model to reduce an error between (i) the expected quality scores generated by processing the example prompts for training examples for the training iteration using the score prediction machine learning model and (ii) the expected quality scores for the reference distributions of data items for the example prompts for the training examples for the training iteration. In particular, the system can jointly train the target generative machine learning model and the score prediction machine learning model by updating the parameters of both models to optimize the objective function.

As part of updating the parameters of the score prediction machine learning model, the system can determine gradients of the objective function (e.g., gradients of the objective function with respect to the parameters of the score prediction machine learning model). For example, for each training example, the system can determine the gradient of the objective function for the score prediction machine learning model following:

$${∇}_{ϕ} ℒ = {∇}_{ϕ} {V}_{ϕ} ( x ) ( {V}_{ϕ} ( x ) - r ( x , y ) + τ log \frac{{π}_{θ} ( y \vert x )}{{π}_{ref} ( y \vert x )} )$$

The system can update the parameters of the score prediction machine learning model using the gradients of the objective function following any appropriate machine learning technique (e.g., following stochastic gradient descent, ADAM, etc.). As described below with reference to FIG. 4, by updating the parameters of the score prediction machine learning model using the above gradient of the objective function, the system can train the score prediction machine learning model to model an accurate approximation of expected quality scores for outputs generated by the reference model.

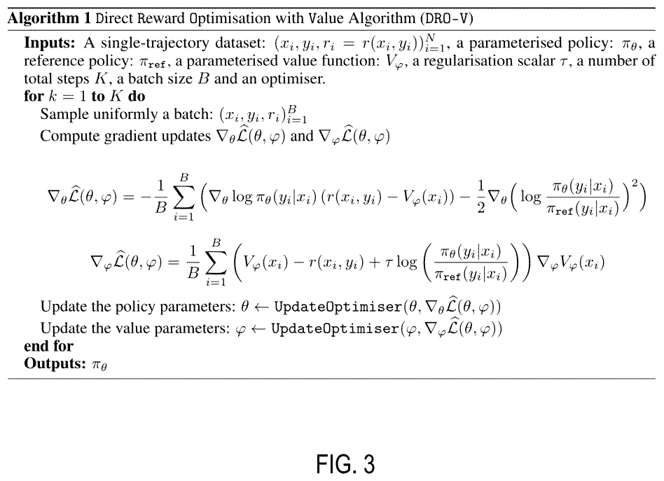

An example algorithm that the system can use to update the parameters of the target generative machine learning model and the parameters of the score prediction machine learning model is illustrated below with reference to FIG. 3.

The system can determine whether training is complete (step 210). The system can use any of a variety of criteria to determine whether the training is complete. For example, the system can determine that training is complete after a pre-determined number of training iterations. As another example, the system can determine that training is complete when a value of the objective function falls below a pre-determined threshold. As another example, the system can determine that training is complete when a difference between values of the objective function for the current training iteration and a previous training iteration falls below a pre-determined threshold.

If the system determines that training is not complete, the system can continue to a next training iteration (e.g., return to step 204)

When the system determines that the training is complete, the system can return the trained target generative machine learning model (step 212).

FIG. 3 illustrates an example algorithm that a training system can use to train a target generative machine learning model. In particular, the algorithm depicted in FIG. 3 can utilize training examples that each include an example input prompt, an example output data item, and a quality score for the example output data item to train model parameters, θ, of the target generative model (e.g., parameterizing a policy π_{θ}). For example, an i-th training example can include an example model input, xᵢ, an example output data item, yᵢ, and an example quality score, rᵢ=r(xᵢ, yᵢ), for the example output data item yᵢ. The algorithm depicted in FIG. 3 can utilize a score prediction machine learning model (e.g., a parameterized value function), V_{φ}, as part of updating the model parameters, θ, of the target generative model and can be used to update the model parameters, φ, of the score prediction machine learning model.

FIG. 4 is a flow diagram of an example process for generating an expected quality score by processing an input prompt using a score prediction machine learning model. For convenience, the process 400 will be described as being performed by a system of one or more computers located in one or more locations. For example, a score prediction system, e.g., the score prediction system 108 of FIG. 1, appropriately programmed in accordance with this specification, can perform the process 400.

The system can receive the input prompt (step 402). In particular, the input prompt can be an example prompt for training a generative machine learning model and the system can receive the input prompt as part of training the generative machine learning model (e.g., following step 206 of the process 200 described above with reference to FIG. 2).

The system can process the input prompt using a score prediction machine learning model to generate the expected quality score (step 404). As described above, the score prediction machine learning model can be configured to process the input prompt to predict an expected quality score for a reference distribution of data items for the example prompt. For example, the score prediction machine learning model can be to approximate a log-sum-exp defined expected quality score:

$$V * ( x ) = τ log {𝔼}_{y ∼ {π}_{ref} ( \cdot \vert x )} [ {e}^{\frac{r ( x , y )}{τ}} ]$$

Where τ is a regularization weight, π_{ref}(·|x) is the reference distribution of data items for the example prompt, x, and r(x, y) is a quality score for a data item y given the example prompt.

In particular, following joint training with the generative machine learning model as described with reference to step 208 of FIG. 2 above, the score prediction machine learning model can be trained to model the expected quality score:

$${V}_{ϕ} ( x ) = {𝔼}_{y ∼ {π}_{ref} ( \cdot \vert x )} [ r ( x , y ) - τ log \frac{{π}_{θ} ( y \vert x )}{{π}_{ref} ( y \vert x )} ]$$

Which can closely approximate the above log-sum-exp defined expected quality score, V*(x).

The reference distribution of data items for the example prompt for the training example can be a distribution of data items determined by processing the example prompt for the training example using a reference generative machine learning model.

As described above with reference to FIG. 2, a training system (e.g., the training system 100 of FIG. 1) can jointly train the score prediction machine learning model with a generative machine learning model to optimize a same objective function. This enables the training system to train the score prediction machine learning model to predict expected quality scores for the reference distribution while the training system also trains the generative model using expected quality scores generated by the score prediction machine learning model.

FIG. 5 illustrates a performance of example generative machine learning models that have been trained using the described methods. In particular, FIG. 5 illustrates results of side-by-side comparisons between outputs generated by generative machine learning models trained to generate text responses to input text prompts using the methods described in this specification (referred to as “DRO-V” in FIG. 5), using supervised fine tuning (SFT), and using Kahneman-Tversky Optimization (KTO).

Kahneman-Tversky Optimization is a method for training using direct human feedback data that relies on certain assumptions regarding risk aversion and utility functions for human feedback. A method of performing Kahneman-Tversky Optimization is described by Ethayarajh, Kawin, et al. in “Model Alignment as Prospect Theoretic Optimization”, Forty-first International Conference on Machine Learning, 2024.

The side-by-side comparisons of the outputs are performed by processing the pair of outputs using a large language model using an evaluation prompt directing the large language model to assess a helpfulness and fulfilment of the outputs.

FIG. 5 shows results for training a generative model with a text encoder having 770 million parameters (“T5-L”) and results for training a generative model with a text encoder having 3 billion parameters (“T5-XL”).

As illustrated in FIG. 5, the outputs generated by the models trained using the methods described in this specification are more often preferred in side-to-side comparison to the outputs generated by the models trained using SFT and to the outputs generated by the models trained using KTO.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
training a target generative machine learning model, the training comprising, at each of a sequence of training iterations:
obtaining a plurality of training examples for the training iteration, wherein each training example includes:
(i) an example prompt for the training example,
(ii) an example data item for the training example, and
(iii) a quality score for the training example that measures a quality of the example data item given the example prompt;
determining, for each of the plurality of training examples for the training iteration, a likelihood of the target generative machine learning model generating the example data item by processing the example prompt for the training example;
determining, for each of the plurality of training examples for the training iteration, an expected quality score for the training example; and
training the target generative machine learning model to optimize an objective function, wherein the objective function depends on, for each training example for the training iteration, (i) the likelihood of the target generative machine learning model generating the example data item by processing the example prompt for the training example and (ii) a difference between the quality score for the training example and the expected quality score for the training example.

2. The method of claim 1, wherein the objective function includes a regularization term that measures, for each training example, a difference between a distribution of data items determined by processing the example prompt for the training example using the target generative machine learning model and a regularization distribution of data items for the example prompt for the training example.

3. The method of claim 2, wherein the regularization term measures, for each training example, a difference between (i) the likelihood of the target generative machine learning model generating the example data item by processing the example prompt for the training example and (ii) a likelihood of the example data item for the training example as determined by the regularization distribution of data items for the example prompt for the training example.

4. The method of claim 2, wherein the regularization distribution of data items for the example prompt for the training example is a distribution of data items determined by processing the example prompt for the training example using a regularization generative machine learning model.

5. The method of claim 1, wherein, for each training example, the expected quality score for the training example is an expected quality score for a reference distribution of data items for the example prompt for the training example.

6. The method of claim 5, wherein the reference distribution of data items for the example prompt for the training example is a distribution of data items determined by processing the example prompt for the training example using a reference generative machine learning model.

7. The method of claim 6, when dependent on claim 4, wherein the reference generative machine learning model is the regularization generative machine learning model.

8. The method of claim 1, wherein, for each of the plurality of training examples for the training iteration, determining the expected quality score for the training example comprises:
processing the example prompt for the training example using a score prediction machine learning model to generate the expected quality score for the training example.

9. The method of claim 8, when dependent on claim 5, wherein training the target generative machine learning model to optimize the objective function comprises:
training the score prediction machine learning model to reduce an error between (i) the expected quality scores generated by processing the example prompts for training examples for the training iteration using the score prediction machine learning model and (ii) the expected quality scores for the reference distributions of data items for the example prompts for the training examples for the training iteration.

10. The method of claim 9, wherein training the score prediction machine learning model to reduce the error between (i) expected quality scores generated by processing the example prompts for training examples for the training iteration using the score prediction machine learning model and (ii) the expected quality scores for the reference distributions of data items for the example prompts for the training examples for the training iteration comprises:
jointly training the target generative machine learning model and the score prediction machine learning model to optimize the objective function.

11. The method of claim 1, wherein the target generative machine learning model comprises a language model.

12. The method of claim 1, wherein the target generative model comprises an image generation neural network.

13. The method of claim 1, wherein for each training iteration:
for each training example for the training iteration, the example data item for the training example comprises a response to the example prompt for the training example and the quality score for the training example measures a quality of the example data item as a response to the example prompt for the training example.

14. The method of claim 1, wherein:
the target generative machine learning model is configured to process input token sequences to generate corresponding output token sequences, wherein the input token sequence and the output token sequence comprise tokens from a vocabulary of tokens for the target machine learning model; and
for each training iteration and for each of the plurality of training examples for the training iteration:
the example prompt for the training example comprises a respective example input token sequence; and
the example data item for the training example comprises a respective example output token sequence.

15. The method of claim 1, wherein:
the target generative machine learning model is configured to interact with a user;
for each training example, the example prompt for the training example comprises an example of a query from an example user for the training example; and
for each training example, the example data item for the training example comprises a response to a respective example of a query from the example user for the training example.

16. The method of claim 1, wherein:
the target generative machine learning model is configured to select actions for an agent interacting with an environment to perform a task in the environment; and
for each training example, the example data item for the training example comprises a selected action for an example agent to perform the task in an example environment for the training example.

17. The method of claim 16, wherein:
for each training example, the example prompt for the training example comprises a respective observation of the example environment for the training example.

18. The method of claim 1, further comprising, after training the target generative model:
receiving a prompt; and
generating a data item by processing the prompt using the target generative machine learning model.

19. A system comprising:
one or more computers; and
one or more storage devices communicatively coupled to the one or more computers, wherein the one or more storage devices store instructions that, when executed by the one or more computers, cause the one or more computers to perform operations comprising:
training a target generative machine learning model, the training comprising, at each of a sequence of training iterations:
obtaining a plurality of training examples for the training iteration, wherein each training example includes:
(i) an example prompt for the training example,
(ii) an example data item for the training example, and
(iii) a quality score for the training example that measures a quality of the example data item given the example prompt;
determining, for each of the plurality of training examples for the training iteration, a likelihood of the target generative machine learning model generating the example data item by processing the example prompt for the training example;
determining, for each of the plurality of training examples for the training iteration, an expected quality score for the training example; and
training the target generative machine learning model to optimize an objective function, wherein the objective function depends on, for each training example for the training iteration, (i) the likelihood of the target generative machine learning model generating the example data item by processing the example prompt for the training example and (ii) a difference between the quality score for the training example and the expected quality score for the training example.

20. One or more non-transitory computer storage media storing instructions that when executed by one or more computers cause the one or more computers to perform operations comprising:
training a target generative machine learning model, the training comprising, at each of a sequence of training iterations:
obtaining a plurality of training examples for the training iteration, wherein each training example includes:
(i) an example prompt for the training example,
(ii) an example data item for the training example, and
(iii) a quality score for the training example that measures a quality of the example data item given the example prompt;
determining, for each of the plurality of training examples for the training iteration, a likelihood of the target generative machine learning model generating the example data item by processing the example prompt for the training example;
determining, for each of the plurality of training examples for the training iteration, an expected quality score for the training example; and
training the target generative machine learning model to optimize an objective function, wherein the objective function depends on, for each training example for the training iteration, (i) the likelihood of the target generative machine learning model generating the example data item by processing the example prompt for the training example and (ii) a difference between the quality score for the training example and the expected quality score for the training example.
